(19) United States
(12) Patent Application Publication
(10) Pub. No.: US 2016/0299905 A1
(43) Pub. Date: Oct. 13, 2016

(54) GEOGRAPHIC LOCATION LINKED SEARCHING AND RECORD ACCESS SYSTEMS AND METHODS

(71) Applicant: Tripping International, Inc., San Francisco, CA (US)

(72) Inventors: Markus Geyer, Berkeley, CA (US); Danny Chi, Livermore, CA (US); Colin Gardiner, San Francisco, CA (US)

(73) Assignee: Tripping International, Inc., San Francisco, CA (US)

(21) Appl. No.: 15/088,731

(22) Filed: Apr. 1, 2016

Related U.S. Application Data
(60) Provisional application No. 62/144,164, filed on Apr. 7, 2015.

(51) Int. Cl. G06F 17/30; G06F 17/22; G06F 3/0482; H04L 29/08; G06F 3/0484

(52) U.S. Cl. CPC G06F 17/30061; G06F 17/30241; H04L 67/02; G06F 17/30424; G06F 17/30398; G06F 3/0484; G06F 3/0482; G06F 17/2235; G06F 17/30902

(57) ABSTRACT

Various arrangements are presented for geographic location linked searching and record access. A database may be accessed to retrieve geographic location listings that are within a geographic region defined by geographic search criteria. An interactive map may be provided within a browser that indicates a plurality of greater-emphasis geographic markers that correspond to the geographic location listings. After receiving records corresponding to geographic location listings, another request may be created that requests additional geographic location listings and an exclusion request that excludes previously-provided geographic location listings. The interactive map may then be caused to present a plurality of lesser-emphasis geographic markers concurrently with the plurality of greater-emphasis geographic markers, wherein each lesser-emphasis geographic marker of the plurality of lesser-emphasis geographic markers corresponds to a geographic location of the second set of geographic location listings.

### CROSS-REFERENCES TO RELATED APPLICATIONS

This application claims the benefit of and priority to U.S. Provisional Application No. 62/144,164, filed Apr. 7, 2015, attorney docket number 097938-0935775. This provisional application is hereby incorporated by reference for all purposes.

### BACKGROUND

Performing geographic searches, such as for information about a geographic location or property, can be cumbersome for a user. Frequently, a user may be presented with a vast number of results that are difficult to manage or understand by the user. However, by simply decreasing the number of results output by a search engine and listed to the user, results that may be important to the user may be absent. According, a search engine system that organizes and manages records related to geographic searching that both prevents a user from being overwhelmed with search results, but still provides a large number of search results for the user to analyze may be beneficial.

### SUMMARY

Systems, methods, and non-transitory computer-readable mediums are detailed herein that provide for geographic location linked searching and record access. A first request may be received by a geographic search system from a browser of a user computer system that comprises geographic search criteria. The geographic search system may access a database to retrieve geographic location listings that are within a geographic region defined by the geographic search criteria. The geographic search system may identify a first set of geographic location listings that match the geographic search criteria. The geographic search system may transmit, to the browser of the user computer system, a first set of records that indicate the first set of geographic location listings. The geographic search system may cause an interactive map to be provided to the browser of the user computer system, the interactive map comprising a plurality of greater-emphasis geographic markers, wherein each greater-emphasis geographic marker of the plurality of greater-emphasis geographic markers corresponds to a geographic location listing of the first set of geographic location listings. The browser of the user computer system may transmit a second request that comprises: a request for additional geographic location listings and an exclusion request, wherein the exclusion request indicates the first set of geographic location listings. The geographic search system may identify a second set of geographic location listings that match the geographic search criteria and excludes the first set of geographic location listings. The geographic search system may transmit to the browser of the user computer system, a second set of records that indicate the second set of geographic location listings. The geographic search system may cause the interactive map to present a plurality of lesser-emphasis geographic markers concurrently with the plurality of greater-emphasis geographic markers, wherein each lesser-emphasis geographic marker of the plurality of lesser-emphasis geographic markers corresponds to a geographic location of the second set of geographic location listings.

Embodiments of such systems, methods, and computer-readable mediums may include one or more of the following features: The geographic search system may transmit instructions to the browser of the user computer system that causes a window of the browser to simultaneously present: a plurality of graphical record listings, wherein each graphical record listing of the plurality of graphical record listings correspond to a different record of the first set of records; and the interactive map. The geographic search system may transmit instructions to the browser of the user computer system that cause the browser to simultaneously present with the plurality of graphical record listings and the interactive map, a single popup graphical record listing overlaid onto the interactive map in response to user selection of a lesser-emphasis geographic marker. The browser may transmit to a third-party map provider application programming interface: coordinates indicative of the geographic region, a first image corresponding to the greater-emphasis geographic marker, a second image corresponding to the lesser-emphasis geographic marker, identifiers corresponding to the first set of records and the second set of records, and coordinates corresponding to each record of the first set of records and the second set of records. The browser may receive the interactive map that comprises the plurality of lesser-emphasis geographic markers and the plurality of greater-emphasis geographic markers. The geographic search system may access a plurality of third-party geographic listing APIs to retrieve records corresponding to a superset of geographic location listings. The geographic search system may update the database that includes a superset of records corresponding to the superset of geographic location listings. Records of the superset of records may be compared with each other to identify duplicative records, wherein duplicative records correspond to a same geographic location listing. Comparing the records of the superset of records with each other to identify duplicative records may include: comparing a first record received from a first third-party geographic listing API with a second record received from a second third-party geographic listing API based on geographic coordinates, record title, and images; and identifying that the first record and the second record are duplicative based on the comparison. Transmitting the first set of records that indicate the first set of geographic location listings to the browser may include a single record indicative of: the first record received from the first third-party geographic listing API and the second record received from the second third-party geographic listing API. The browser may receive user selection of a record selected from the first set of records or the second set of records. The browser may transmit an indication of the record to the geographic search system. The browser may cause either the greater-emphasis geographic marker or the lower-emphasis geographic marker associated with the record to be presented on the interactive map to be changed from a first graphical format to a second graphical format. The browser of the user computer system storing the first set of records and the second set of records as a single set of records in a common format. In response to selection of a greater-emphasis geographic marker, the browser of the user computer system may identify a graphical record listing of a plurality of graphical record listings corresponding to the greater-emphasis geographic marker. The browser of the user computer system may then execute an automated scroll event such that the graphical record listing is presented simultaneously with the selected greater-emphasis geographic marker.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an embodiment of a web-based geographic location search engine interface that presents geographic markers having varying levels of emphasis.

FIG. 2 illustrates another embodiment of a web-based geographic location search engine interface that presents geographic markers having varying levels of emphasis.

FIG. 3 illustrates an embodiment of a web-based geographic location search engine interface that presents an on-map thumbnail is presented for a lesser-emphasis geographic marker.

FIG. 4 illustrates an embodiment of a system for geographic location linked searching and record access.

FIG. 5 illustrates an embodiment of a system for in-browser management and interfacing with geographic listing records.

FIGS. 6A, 6B, and 6C illustrate abstractions of how geographic listing records are selected to be associated with greater- and lesser-emphasis geographic markers.

FIGS. 7A and 7B illustrate an embodiment of a method for providing a web-based geographic location search engine interface in a user's web browser.

FIG. 8 illustrates an embodiment of a method for executing the web-based geographic location search engine interface in a user's web browser.

FIG. 9 illustrates an embodiment of a method for identifying duplicate geographic location listings and incorporating such duplicate geographic location listings in results.

FIG. 10 illustrates an embodiment of a computer system.

### DETAILED DESCRIPTION

A geographic search engine may return results that correspond to various geographic locations. These search results may be selected based on the results conforming to a geographic region searched by a user. Additional search criteria may also be used to select particular results. When such a search is performed for real estate listings, such as for rental properties, typical search terms may include a price per night, a number of bedrooms, a number of bathrooms, amenities, a price range, etc. Results may be returned that match all of the user's defined search criteria or that best match the user's defined search criteria if no or few exact matches are found.

When such geographic search engine results are provided to a user, the user may benefit from having the results presented on an interactive map that allows for panning, zooming, and/or otherwise being manipulated. Presentation on a map may allow the user to pinpoint where each listing result is located. However, when the geographic search engine returns a large number of results, such as tens, hundreds, or even possibly thousands of results, the user's ability to quickly parse such results on a map may be decreased. In order to allow the user to quickly view the best ranked geographic listing records provided by the geographic search engine, a first subset of the geographic listing records may be represented using greater-emphasis geographic location indicators while the remainder of the set of geographic listing records may be represented by lesser-emphasis geographic location indicators. The geographic search engine defines which results are assigned greater- or lower-emphasis geographic location indicators. Results selected by the geographic search engine to be represented by greater-emphasis geographic location indicators can be linked with an on-page record display. This on-page record display presents pertinent details, such as one or more thumbnail images, nightly price, and link to book the property, associated with the geographic listing record.

Geographic listing records associated with lesser-emphasis geographic location indicators, however, may not be associated with such an on-page record display. Geographic listing records represented by lesser-emphasis geographic location indicators may be stored by a user's web browser in the background the same as storage of geographic listing records represented by greater-emphasis geographic location indicators. However, information about the geographic listing record represented by the lesser-emphasis geographical location marker may only be presented if the user interacts with the lesser-emphasis geographic location indicator, such as by selecting it (e.g., clicking on the marker with a cursor or touching the marker on a touch-screen). If the user performs such an interaction, a pop-up window may be presented by the user's web browser overlaying the interactive map display.

All geographic listing records returned by the geographic search engine may be presented, at varying times, as being associated with greater-emphasis geographic location indicators. When an initial set of geographic listing records associated with greater-emphasis geographic location indicators are provided, the user's web browser may request in a message to the geographic search engine to return additional results associated with lesser-emphasis geographic location indicators. This message may include an instruction to exclude the initial set of records associated with the greater-emphasis geographic location indicators. At a later time, the user may request a second set of results associated with greater-emphasis geographic location indicators. The geographic search engine may select a second set of results to be associated with greater-emphasis geographic location indicators. These geographic listing records were previously represented by lesser-emphasis geographic location indicators. After being provided to the user's web browser, the web browser may again request in a message to the geographic search engine to return additional results represented by lesser-emphasis geographic location indicators; this message may explicitly request that the second set of results be excluded from the additional results. This second set of lesser-emphasis geographic location indicators can include geographic listing records that were initially represented by greater-emphasis geographic location indicators. This set of lesser-emphasis geographic location indicators also can include geographic listing records that were also initially presented in association with lesser-emphasis geographic location indicators.

While the above example is based on two requests being used to obtain an initial set and a second set of results, it should be understood that in other embodiments, a single request or more than two requests may be used. For example, a single request may be used to obtain both a first and second set of results or, perhaps, only a single set of results. In another example, a string of requests may be used to increase the number of results that are returned as part of the initial and/or second set; each subsequent request may, for example, request 500 additional results, which can be used to grow the second set to several thousand geographic listing records. Further detail regarding how such a geographic search engine functions in conjunction with a user's web browser is detailed in relation to the figures that follow.

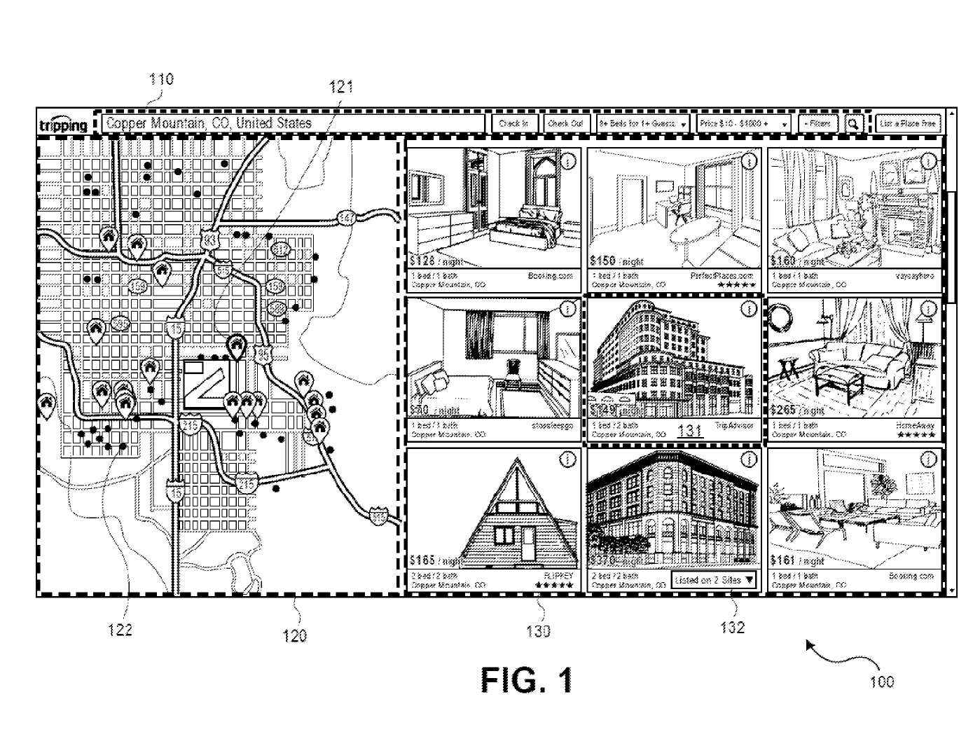

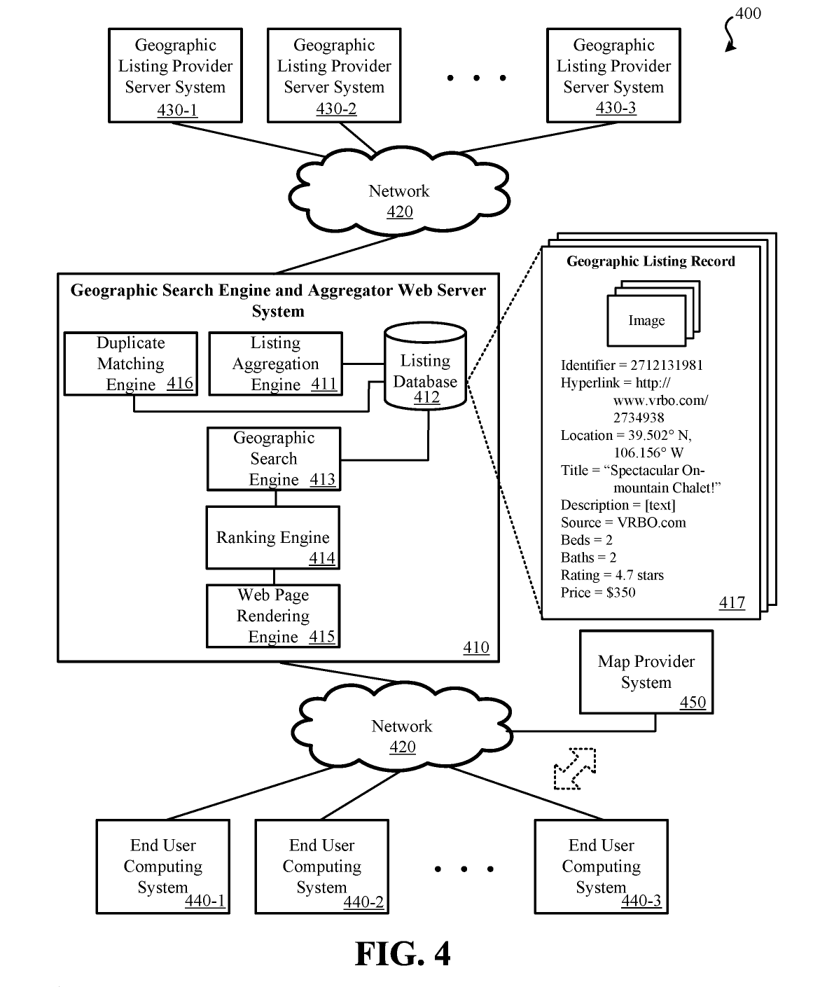

FIG. 1 illustrates an embodiment of a web-based interface 100 that presents geographic markers having varying levels of emphasis. Such a web-based interface 100 may be output by a geographic search engine web server system (as detailed in relation to FIG. 4), via the Internet, to various end user computing devices, such as desktop computers, laptop computers, cellular mobile devices (e.g., smartphone), tablet computers, etc. Web-based interface 100 may represent a single webpage presented by a web browser. Such a web browser may use JavaScript® or some other (possibly object-oriented) computer programming language that can be used to create interactive effects to render web-based interface 100 within the web browser.

Web-based interface 100 may be configured to receive geographic search criteria via search region 110. Search region 110 may permit an end user to specify: an address, a zip code, a city/town, a county, a desired check-in date, a desired check-out date, a number of beds and/or bedrooms, a number of guests that will be staying at a property, a price range (a maximum and/or a minimum price the user desires to pay), and/or a number of additional filters that are used to define a geographic region and filter geographic listing records within that geographic region that are desired to be viewed by the end user. Based upon search criteria submitted via search region 110 (or another search interface not illustrated in web-based interface 100), a webserver may identify a geographic region that corresponds to the end user's defined geographic area and identify property listings from a database that fall within the defined geographic area and meet all (or at least some) of the end user's submitted search criteria.

Within a web browser window, a web-based interface may be presented that includes: interactive map 120 and on-page record region 130. Interactive map 120 is presented for at least some of the defined geographic region that corresponds to the end user's search (e.g., a portion of the region may be excluded if no results are present in this portion). For some or all of the geographic listing records retrieved from a database searched by the geographic search engine that fall within the defined geographic area, geographic markers are presented on interactive map 120 corresponding to geographic locations stored within the retrieved geographic listing records.

The geographic listing records retrieved from the database may be analyzed by the geographic search engine according to various criteria to determine a ranking for the records. The criteria can include, in addition to those previously indicated: characteristics of the geographic listing records (e.g., how well it matches the end user's search), a quality score of the property listing (e.g., number of pictures, user reviews, number of views), proximity to the user's desired location (e.g., if an address or point is defined by the user's search criteria, closer properties may be given preference), and/or the booking website from which the property listing originates.

Following performing the ranking, a first set of geographic listing records may be provided to the user's browser. This first set may be a relatively small number of records, such as thirty-six. It should be understood that in other embodiments greater or fewer records may be returned as part of this first set of geographic listing records transmitted by the geographic search engine to the user's browser. Each geographic listing record of the first set is assigned by the geographic search engine to be represented on interactive map 120 by a greater-emphasis geographic marker and also within on-page record region 130.

A second set of geographic listings may be determined by the geographic search engine. In some embodiments, a superset is initially determined by the geographic search engine, from which the first set and then the second set is selected. In other embodiments, two separate searches are performed using the same search criteria provided by the user; the first search being used to obtain the first set and the second search being used to obtain the second set.

Geographic listing records of the second set of search results may be represented by lesser-emphasis geographic markers on interactive map 120. In some embodiments, only up to a predefined number of lesser-emphasis geographic markers may be presented at a given time, such as 100 or 1000. Typically, a greater number of lesser-emphasis geographic markers are presented on interactive map 120 at a given time than greater-emphasis geographic markers. The lesser-emphasis geographic markers are placed on interactive map 120 in locations corresponding to the geographic location of the property listing. Such lesser-emphasis geographic markers are smaller and/or less visually prominent than greater-emphasis geographic markers.

In some embodiments, interactive map 120 is sourced from a third-party map provider. For instance, a map provider, such as Google®, may provide an application programming interface (API) that allows other parties to define how an interactive map should be output for incorporation within a webpage. With the region of the web browser window that presents interactive map 120, the map provider may maintain control over content. However, it may be possible for the webpage to overlay additional information. The geographic search engine may provide data to the third-party map provider via code passed to the user's browser which, in turn, passes such information to the API. The third-party map provider uses this information to create and serve interactive map 120 to the user's browser. Such data may include: coordinates defining the region of the map, coordinates corresponding to geographic listing records that will be presented with greater-emphasis geographic markers, a graphic for use as the greater-emphasis geographic marker, coordinates corresponding to geographic listing records that will be presented with lesser-emphasis geographic markers, a graphic for use as the lesser-emphasis geographic marker, and unique identifiers for each geographic listing record (as compared to other geographic listing records provided to the web browser).

Greater-emphasis geographic marker 121 is an example of a greater-emphasis geographic marker. Greater-emphasis geographic marker 121 is larger than lesser-emphasis geographic marker 122 and more visually prominent. Greater-emphasis geographic marker 121 signifies to the end user interacting with the web browser that a corresponding record is presented as part of on-page record region 130. Each on-page record (e.g., on-page record 131) presented in on-page record region 130 corresponds to a currently-presented greater-emphasis geographic marker presented on interactive map 120. Similarly, each currently-presented greater-emphasis geographic marker presented on interactive map 120 corresponds to an on-page record in on-page record region 130. Depending on the number of records presented in on-page record region 130, it may be necessary for the user to scroll to see all of the on-page records presented in on-page record region 130.

Lesser-emphasis geographic marker 122 is an example of a lesser-emphasis geographic marker. Lesser-emphasis geographic marker 122 is smaller in area than greater-emphasis geographic marker 121 and is generally less visually prominent. Lesser-emphasis geographic marker 122 may not have a graphical indication present on it (e.g., the house icon present on greater-emphasis geographic marker 121); the lack of graphical indication can signify to the end user that a corresponding on-page record is not presented within on-page record region 130.

If a user selects (e.g., clicks on, hovers over, touches on a touchscreen interface) a greater-emphasis geographic marker such as greater-emphasis geographic marker 121, focus may be transferred to the corresponding on-page record presented in on-page record region 130. Focus being transferred may involve the on-page record, such as on-page record 131, being highlighted or otherwise emphasized. To accomplish this, interactive map 120 may determine a unique identifier associated with selected greater-emphasis geographic marker 121. This unique identifier may be passed by the code associated with interactive map 120 to the code being executed that manages record presentation. This code being executed by the browser may determine a corresponding on-page record is being presented and may highlight the corresponding on-page record. The on-page record region 130 may have a sufficient number of on-page records that focus being transferred may also involve on-page record region 130 being scrolled such that the on-page record region 130 (without user input specifically causing the scrolling) presents on-page record 131, which is additionally highlighted or otherwise emphasized. A JavaScript® command may then be used to execute a scroll within on-page record region 130 of the webpage such that the on-page record corresponding to the identifier is made visible.

As an example, if a user selects greater-emphasis geographic marker 121, on-page record region 130 may scroll, if necessary, based on a JavaScript® command and on-page record 131 may be emphasized to convey to the user that on-page record 131 corresponds to greater-emphasis geographic marker 121. Similarly, greater-emphasis geographic marker 121 may be emphasized to clearly indicate the relationship between greater-emphasis geographic marker 121 and on-page record 131. The reverse situation may also be possible, when a user selects on-page record 131, a lookup of an identifier in the associated geographic listing record may be performed locally by the web browser to determine a unique identifier. This unique identifier may then be used to identify corresponding greater-emphasis geographic marker 121. A position of interactive map 120 may be readjusted, if necessary, such that greater-emphasis geographic marker 121 is presented. Both greater-emphasis geographic marker 121 and on-page record 131 may be emphasized to clearly indicate the relationship, such as by highlighting, outlining, a size change, and/or a color change.

On-page record 131, when selected by a user, may have an embedded hyperlink to an interstitial webpage hosted by the geographic search engine. When selected by a user, this interstitial webpage may be requested by the web browser from the geographic search engine. In response, the geographic search engine may log which geographic listing record the user is attempting to access and an indication of the user. The geographic search engine may then forward or redirect the web browser's request to a third-party geographic listing provider that is the host of geographic listing.

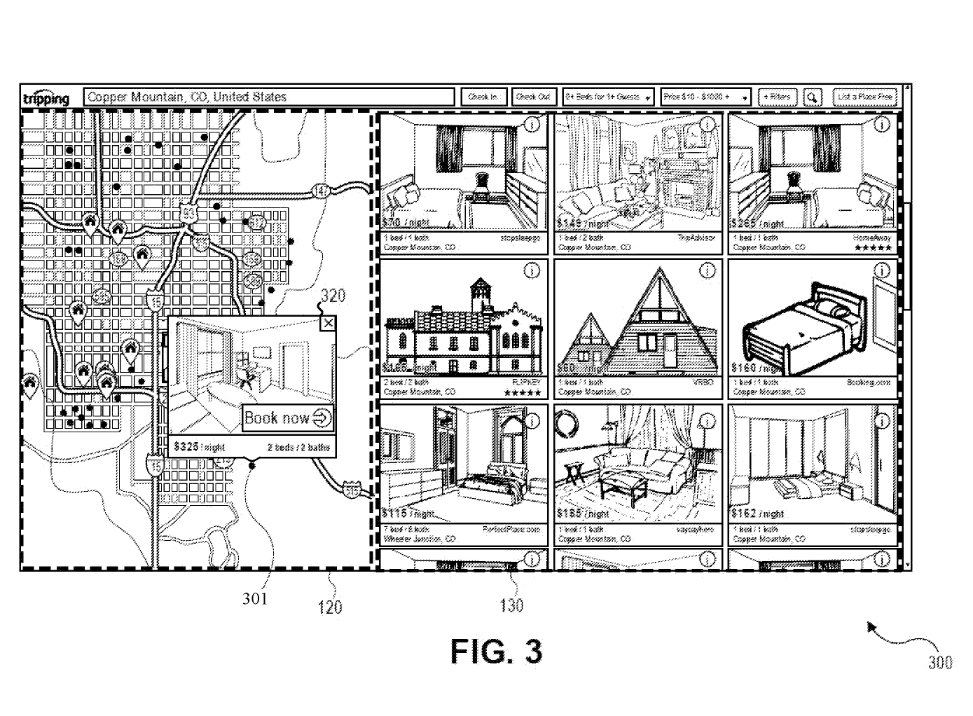

If a user selects a lesser-emphasis geographic marker such as lesser-emphasis geographic marker 122, a pop-up thumbnail may be presented overlaid on interactive map 120. The greater- and lesser-emphasis indicators may be overlaid onto the map by a third-party map provider. Similarly, the overlay pop-up may be rendered on top of the map by the third-party's interactive map code based on HTML code provided by the user's browser to the map provider. By the user selecting an associated lesser-emphasis geographic marker, this may trigger the code that causes the pop-up thumbnail to be locally executed by the user's browser. Further detail regarding the pop-up thumbnail is provided in relation to FIG. 3.

Each instance of an on-page record within on-page record region 130 may contain various pieces of information. Each on-page record region may include, for example: a per night price, a thumbnail picture representative of the property, an indication of a booking website from which the listing was retrieved and to which the user will be redirected if the thumbnail listing is selected by the user, a written indication of the location (e.g., a city and state), a number of bedrooms, a number of bathrooms, and/or a user rating. In other embodiments, fewer or additional pieces of information may be presented for each on-page record in on-page record region 130. This information may be stored by the user's browser in the form of geographic listing records. Geographic listing records may be stored by the browser for every geographic listing record presented on interactive map 120, including both those associated with greater- and lesser-emphasis geographic markers. While the information related to lesser-emphasis geographic markers is maintained in the background (unless a user selects the corresponding lesser-emphasis geographic marker), information from such geographic listing records are used to present on-page records when associated with a greater-emphasis geographic marker.

In some embodiments, geographic markers, including both greater- and lesser-emphasized geographic markers, may be presented in various colors, various shapes, and/or in relation to various icons to indicate if a user has: 1) previously viewed; or 2) selected the associated geographic listing record as a favorite. Such an alternative presentation may be used for the geographic marker regardless of whether it is greater- or lesser-emphasized. For instance, a geographic listing record selected as a favorite may be presented in a color different from other geographic markers on interactive map 120; and a geographic listing record previously viewed may be presented in another color different from other colors used for geographic markers on interactive map 120. Such alternative presentations (e.g., alternative colors) of geographic markers may persist when a user selects an additional page of results, adjusts the region displayed on interactive map 120, and/or executes a different or modified search. Which geographic listing records have been selected as a favorite or previously viewed may be stored locally by the web browser (e.g., as a field within the geographic listing records) and/or may be transmitted to the geographic search engine for storage in association with an account of the user.

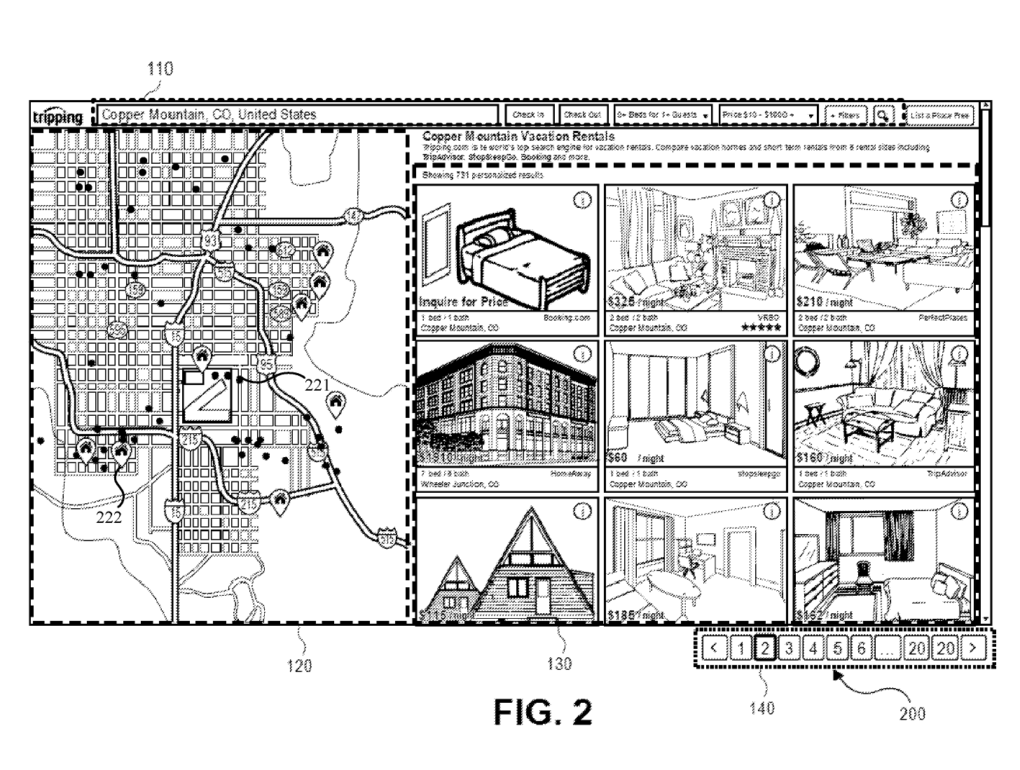

FIG. 2 illustrates an embodiment of web-based interface 200 that presents geographic markers having greater emphasis for locations other than in FIG. 1. By the end user providing input to see a second set of results (e.g., a second page of results), search results assigned greater- and lesser-emphasis geographic markers may be reevaluated such that geographic listing records previously associated with greater-emphasis geographic markers are now each presented in relation with lesser-emphasis geographic markers and at least some geographic listing records previously associated lesser-emphasis geographic markers are now each presented in relation with greater-emphasis geographic markers.

The end user may be able to provide input, such as via page selector 140 of FIG. 2, in web-based interface 200 that causes an update of on-page record region 130. Such user input may trigger the web browser to request a new first set of geographic listing records for the user's search criteria to be associated with greater-emphasis geographic markers and a second set of geographic listing records to be associated with the lesser-emphasis geographic markers. The request for the second set may include an exclusionary command such that the first set is specifically excluded from the second set of results.

As can be seen in FIG. 2, interactive map 120 has been updated from FIG. 1 such that different property listings have greater-emphasis geographical markers and the properties that previously had greater-emphasis geographical markers when the web-based interface 100 of FIG. 1 was presented are now presented with lower emphasis geographic markers. The on-page records of on-page record region 130 now correspond to the geographic listing records linked with the greater-emphasis geographic markers on interactive map 120. Therefore, geographic markers remain presented in the same locations as in the web-based interface 100 of FIG. 1; however which geographic markers receive greater-emphasis and which geographic markers receive lesser-emphasis are updated based on a user's input provided to page selector 140. As an example, the geographic listing record represented by lesser-emphasis geographic marker 122 in FIG. 1 is now represented by greater-emphasis geographic marker 222 in FIG. 2. As an example of the reverse situation, the geographic listing record represented by greater-emphasis geographic marker 121 in FIG. 1 is now represented by lesser-emphasis geographic marker 221 in FIG. 2.

In some embodiments, the entire search is performed by the geographic search engine, but lower results from the search are linked with greater-emphasis geographic markers. In other embodiments, the search results are maintained by the geographic search engine and the search does not need to be re-performed. In either embodiment, updated information may be provided to the third-party map provider such that the map is re-rendered with the newly assigned greater- and lesser-emphasis geographic markers.

FIG. 3 illustrates an embodiment of a web-based interface 300 that presents geographic markers having varying levels of emphasis in which an on-map pop-up thumbnail is presented in association with a lesser-emphasis geographic marker. Web-based interface 300 presents interactive map 120 having the same property listings that receive greater-emphasis geographic markers and lesser-emphasis geographic markers as in FIG. 1. By selecting lesser-emphasis geographic marker 301, an identifier associated with lesser-emphasis geographic marker 301 is passed by interactive map 120 to code being executed by the web browser. Based on this identifier, a geographic listing record stored locally by the web browser is accessed. Using data from the geographic listing record, information from the accessed geographic listing record is presented as a pop-up thumbnail 320 overlaid on interactive map 120. Pop-up thumbnail 320 may present at least some of the same categories of information as to an individual on-page records presented in on-page record region 130. For instance, pop-up thumbnail 320 may include a thumbnail image representative of the geographic listing, a price per night, a number of beds, a number of baths, an indication of a booking website to which the user will be linked if the pop-up thumbnail 320 is selected, a user rating, and/or a location. Pop-up thumbnails may be presented in proximity to lesser-emphasis geographic marker 301, such as by being centered directly above lesser-emphasis geographic marker 301. To be clear, despite pop-up thumbnail 320 not being initially displayed by web-based interface 300, the geographic listing record that includes the data needed to present the pop-up thumbnail was acquired by the web browser of the end user computing device from the geographic search server at the same time as data for the on-page record listings of on-page record region 130. As such, information may not need to be retrieved from the geographic search engine (or any other remote device) to present pop-up thumbnail 320 in response to user selection of lesser-emphasis geographic marker 301. In some embodiments, however, when a user scrolls through thumbnail images accessible through the pop-up thumbnail, these images may be retrieved from a remote database.

In other embodiments, the content for pop-up thumbnail 320 is retrieved from the web server in response to the user selecting lesser-emphasis geographic marker 122. As such, in these embodiments, when the webpage is loaded by the end-user computerized device, only full geographic listing records for greater-emphasis geographic markers may be initially transferred from the web server to the end-user's computer device. For lesser-emphasis geographic markers, the corresponding full geographic listing records may be requested and transmitted in response to the user's selection.

Following pop-up thumbnail 320 being presented as an overlay on interactive map 120, if a user selects another lesser-emphasis geographic marker, a new pop-up thumbnail may be presented corresponding to the now selected lesser-emphasis geographic marker and pop-up thumbnail 320 may be closed. If the end-user instead selects a greater-emphasis geographic marker, pop-up thumbnail 320 may be closed and the corresponding thumbnail listing in on-page record region 130 may be highlighted or otherwise emphasized. At any given time either zero pop-up thumbnails or a single pop-up thumbnail may be presented on interactive map 120.

Pop-up thumbnail 320, when selected (e.g., clicked or touched) by a user, may cause the browser to request a hyperlink of the associated geographic listing record that accesses an interstitial webpage hosted by the geographic search engine, similar to as on-page record 131 functioned. When selected by a user, this interstitial webpage may be requested by the web browser from the geographic search engine. In response, the geographic search engine may log which geographic listing record the user is attempting to access and an indication of the user (e.g., a username). The geographic search engine may then forward or redirect the web browser's request to a geographic listing provider that is the host of geographic listing.

Regarding interactive map 120, the end-user may manipulate interactive map 120 to manually adjust a geographic region to be searched for listings. For instance, the map of interactive map 120 may be dragged in any direction, zoomed in, and/or zoomed out. After performing such adjustments to the map, the user may be able to cause coordinates of the now-displayed map region to be transmitted to the geographic search engine such that the user's search can be performed for this region. The coordinates may have been obtained by the web browser from the third-party map provider.

Further, it should be understood that the embodiments of FIGS. 1 through 3 are merely representative. The presentation of on-page record region 130 and interactive map 120 may be varied such as in locations within the web browser or application and/or in the types and amounts of information presented. The locations, graphical presentations, or specific pieces of information presented in FIGS. 1 through 3 should not be interpreted as limiting on embodiments of the detailed web-based interfaces or the geographic search engine. Moreover, while the illustrations of the previous embodiments are focused on rental property listings, it should be understood that the concepts detailed herein are applicable to more than such type of listings. For instance, the concepts detailed herein can be used to organize an interface for various types of information that pertain to locations which have associated records.

FIG. 4 illustrates an embodiment of a system 400 for geographic location linked searching and record access. System 400 may be used to provide to a user, via a web browser, the interfaces exemplified in FIGS. 1 through 3. System 400 may include: geographic search engine and aggregator web server system 410, network 420, geographic listing provider server systems 430, and end-user computing systems 440, and map provider system 450.

Geographic search engine and aggregator web server system 410 may serve multiple functions, including aggregating geographical listings from multiple geographic listing providers and providing end-users with a geographic search engine interface that allows such aggregated geographic listings to be efficiently reviewed. Geographic search engine and aggregator web server system 410 may include: listing aggregation engine 411, listing database 412, geographic search engine 413, ranking engine 414, webpage rendering engine 415, and duplicate matching engine 416.

Listing aggregation engine 411 may periodically access multiple geographic listing provider server systems to retrieve various geographic listings, such as rental properties. Examples of such geographic listing providers include: VRBO®, Flipkey®, HomeAway®, and Airbnb™. While three such exemplary geographic listing provider server systems (430-1, 430-2, 430-3) are illustrated, it should be understood that greater or fewer numbers of geographic listing provider server systems may be used in other embodiments. Geographic listings may include a location, such as in the form of latitude and longitude coordinates, a title, a description, a number of beds, a number of baths, a customer rating, one or more images, and nightly price, and other possible categories. Listing aggregation engine 411 may access each geographic listing provider server systems API in order to retrieve listings available through such geographic listing providers. Listing aggregation engine 411 may use network 420 to access geographic listing provider server systems 430. Network 420 may represent one or more networks, including the Internet. In some embodiments, geographic search engine and aggregator web server system 410 may serve as the original host for at least some of the geographic listing records stored by listing database 412. As such, if a user selects a link provided to an end user computer system associated with such a geographic listing record, geographic search engine and aggregator web server system 410 may not forward or redirect the browser to a separate geographic listing provider server system, but may rather directly host a booking interface for the property associated with the geographic listing record.

Geographic listings that are retrieved from geographic listing provider server systems 430 may be reformatted, if necessary, and stored by listing aggregation engine 411 in listing database 412. As such, listing database 412 includes up-to-date geographic listing records from multiple geographic listing providers. An indication may be stored as part of each geographic listing record stored within listing database 412 of from which geographic listing provider the geographic listing was obtained along with a hyperlink that references the geographic listing as hosted by the geographic listing provider server system.

Retrieved geographic listings may be stored by listing database 412 as geographic listing records, such as exemplary geographic listing record 417. Geographic listing record 417 has various fields and values for such fields. Such fields can include: a unique identifier, which is unique from identifiers of other geographic listing records; a title; a description; a source; a location; a number of beds; a number of baths; a customer rating; and nightly price. One or more images may also be stored by listing database 412 in association with geographic listing record 417. Other fields may also be present for some or all of geographic listing records stored in listing database 412. For example, dates during which the property associated with a geographic listing record is available or unavailable may be stored within geographic listing records. Geographic listing record 417 may, for example, store at least all of the fields defined in relation to the record data provided to retried records database 515.

Geographic search engine 413 may serve to search listing database 412 based on criteria received from an end-user computing system of end-user computing systems 440 via network 420. As an example, a user may submit search criteria via a web browser executed by end-user computing system 440-1. Geographic search engine 413 may receive a definition of a geographic region, such as coordinates, ZIP Code, a city or town name, a country name, a county name, a resort destination, or landmark. In some embodiments, geographic search engine 413 may receive an indication of a location along with a radius to be searched around the location. In still other embodiments, a user may be permitted to trace an outline on an interactive map such that the trace encloses an area the user desires to be searched. Geographic search engine 413 may also receive other criteria for which listing database 412 may be searched, such as any of the fields that are stored in geographic listing records such as geographic listing record 417. As an example, geographic search engine 413 may search for records that fall within specific location coordinates which may be in the form of latitude and longitude. Geographic search engine 413 may be configured to receive indications of locations in various forms and convert them such that they can be searched based on latitude and longitude. As an example, if a user via end-user computing system 440-1 submits a request to search for geographic listing within “Boulder, Colo.,” geographic search engine 413 may determine a range of latitude and longitude coordinates to search that correspond to Boulder, Colo.

Once geographic search engine 413 has determined results from listing database 412 that match or most nearly match the user's search criteria, ranking engine 414 may rank the results. Ranking engine 414 may use various criteria to determine an order in which the results should be ranked. Such criteria may include: how close of a match the results obtained by geographic search engine 413 conformed to the search criteria provided by the user, customer ratings (e.g., higher-ranked listings are ranked above lower-ranked listings), price (e.g., highest to lowest, lowest to highest), how close a location of the geographic listing corresponds to a location specified in the users search criteria (e.g., user specified a landmark or coordinates to search around), and/or the geographic listing provider from which the geographic listing was obtained, etc. Ranking engine 414 may be incorporated as part of geographic search engine 413.

Webpage rendering engine 415 may serve to cause interfaces similar to those presented in FIGS. 1 through 3 to be presented via a browser on end-user computing system 440-1 through which the search request was submitted. Webpage rendering engine 415 based upon the results provided by geographic search engine 413 and the ranking performed by ranking engine 414 may determine which results are to be initially represented using greater-emphasis geographic markers and which results are to be initially represented using lesser-emphasis geographic markers.

The webpage served by webpage rendering engine 415 to end-user computing system 440-1 may include: a first set of geographic listing records, such as similar to geographic listing record 417. The webpage provided to the end-user computing system may include code (e.g., HTML, XML, or JavaScript®) that causes each geographic listing record of the first set to be presented in the on-page record region of the interface presented in the web browser. Additionally, the webpage provided to the end-user computing system may include code that causes the web browser to access a map provider system API for a particular geographic region that corresponds to the search requested by the user. The served webpage may include code that causes the web browser to provide the map provider system's API with: coordinates of a map region to be presented, coordinates of each geographic listing of the first set, and a graphic to be presented on the map for each geographic listing of the first set. This graphic may correspond to the greater-emphasis geographic marker.

After the first set is received by the web browser of end-user computing system 440-1, the web browser may request additional results from webpage rendering engine 415. The additional results requested from webpage rendering engine 415 may be a predefined amount, such as 1000, or a number selectable by the user interacting with the web browser. This request may include an exclusionary command such that of the additional results returned all results from the first set are excluded from being returned a second time. The exclusionary command may include the unique identifiers of each geographic listing of the first set. In response to this additional request and the exclusionary command, webpage rendering engine 415 may provide the end-user computing system with a second set of additional results, which correspond to lower-ranked results as determined by ranking engine 414. Obtaining the second set of results may involve geographic search engine 413 re-executing the search according to the submitted search criteria or a previous listing of ranked results being accessed to select the second set of results that excludes the first set as indicated by the exclusionary command. This second set of results may be provided to the web browser of end-user computing system 440-1 along with instructions that cause the web browser to provide coordinates of each geographic listing from the second set to map provider system 450 along with a graphic to be presented on the map for each geographic listing of the second set. This graphic may correspond to the lesser-emphasis geographic marker. Accordingly, the interactive map (interactive referring to the idea that a user can pan and zoom the map) served by map provider system 450 has the greater- and lesser-emphasis graphical markers embedded on the interactive map. The interactive map may be coded and provided to the web browser in such a way that when either a greater- or lesser-emphasis geographic marker is selected, the identifier associated with the geographic marker is passed by the interactive map applet to the web browser. The web browser may store geographic listing records for both the first set and the second set of geographic listing records in a same manner.

Map provider system 450 may represent a third-party map provider that provides an API that allows web browsers to request maps of particular regions along with location identifiers to be placed on such maps by the map provider system. By webpage rendering engine 415 coding the webpage served to the end-user computing system appropriately, the web browser presenting the webpage may request the map from map provider system 450. It should be understood that in other embodiments, a map generation engine may be incorporated as part of geographic search engine and aggregator web server system 410, thus allowing both the map and the remainder of the interface to be delivered to the end-user computing system from a single source.

End-user computing systems 440 (which by way of example only, includes end-user computing systems 440-1, 440-2, and 440-3) may be any form of computing system that can execute and display a web browser. Typically, such a computing systems may include a desktop computer, laptop computer, a tablet computer, and smart phone. In some embodiments, a dedicated application may be used instead of a web browser to present similar interfaces to FIGS. 1 through 3 and as described herein.

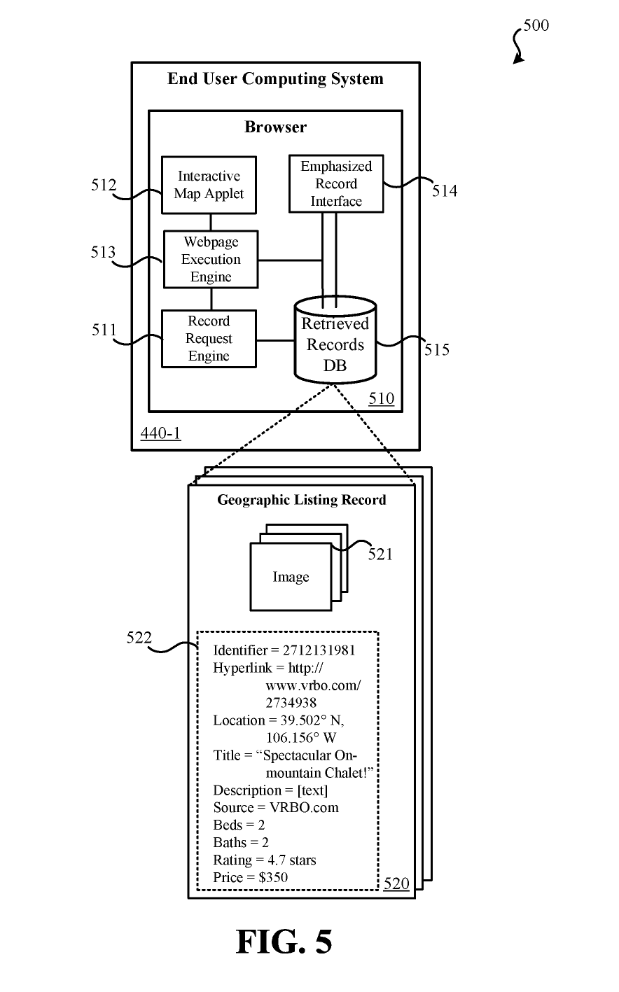

FIG. 5 illustrates an embodiment of a system 500 for in-browser management and interfacing with geographic listing records. System 500 may be executed by a browser of an end-user computing system such that system 500 functions as part of system 400. System 500 may include browser 510 which is being executed by end-user computing system 440-1 (by way of example only) executing the following components: record request engine 511, interactive map applet 512, webpage execution engine 513, emphasized record interface 514, and retrieved records database 515. Each of these components may be received as code, such as HTML, XML, and/or JavaScript code, that is executed by browser 510.

Webpage execution engine 513 may serve to coordinate and handle interactions between interactive map applet 512, emphasized record interface 514, record request engine 511, and retrieved records database 515. Interactive map applet 512 may be provided by and controlled by a third-party map interface provider. Code provided by geographic search engine and aggregator web server system 410 may include code that causes interactive map applet 512 to be called. This code may include coordinates for which the map is to be initially presented by browser 510. Based on calls made to map provider system 450, interactive map applet 512 may be presented within browser 510. Interactive map applet 512 may allow a user to pan, reposition, zoom in, zoom out, and/or otherwise manipulate the map being presented. Data related to the user interaction with interactive map applet 512 within browser 510 may be controlled by interactive map applet 512 such that the status is not shared with geographic search engine and aggregator web server system 410, but rather is only exchanged between browser 510 and map provider system 450. Therefore, unless specific commands are executed, geographic search engine and aggregator web server system 410 may not receive data indicative of how a user is interacting with interactive map applet 512.

When a user selects a greater or lesser-emphasis marker that is present on the map being presented by interactive map applet 512, indication of this marker may be passed to webpage execution engine 513. This indication may be a unique identifier that distinguishes these selected marker from all other markers being presented by interactive map applet 512.

Record request engine 511 may serve to request geographic listing records from geographic search engine and aggregator web server system 410. When the search results are initially loaded by browser 510, a first set of geographic listing records may be provided by geographic search engine and aggregator web server system 410. These records may be stored by browser 510 in retrieved records database 515. As an example, a geographic listing record as provided to retrieved records database 515 may be in a format similar to:

```
{
  “bounds”:{
  “north”:37.86969726941999,
  “south”:37.59926525358023,
  “east”:−122.25405010302734,
  “west”:−122.64475139697265
  },
  “geoDetails”:{
  “GeographyName”:“San Francisco”,
  “Latitude”:37.73448126150011,
  “Longitude”:−122.44940075
  },
  “rentalResults”:{
  “total”:2000,
  “results”:[
    {
    “id”:12345,
    “property_id”:6789,
    “title”:“Example Property”,
    “description”:“This is an example property”,
    “amenities”:[1,2,3,4,5],
    “avgrating”:4,
    “photo”:“http://www.tripping.com/media.jpeg”,
    “inquiryallowed”:false,
    “isfeatured”:0,
    “url”:“http://www.3rdpartylistingprovider.com/23943248”,
    “source”:“Test Partner”,
    “instantbook”:false,
    “location”:{
      “city”:“San Francisco”,
      “state”:“CA”,
      “country”:“US”,
      “latitude”:“37.78966958”,
      “longitude”:“−122.40733928”
    },
    “price”:{
      “currency”:“USD”,
      “symbol”:“$”,
      “amount”:106
    },
    “details”:[
      {
      “name”:“Room Type”,
      “value”:78
      },
      {
      “name”:“Bedrooms”,
      “value”:1
      },
      {
      “name”:“Bathrooms”,
      “value”:“1.0”
      },
      {
      “name”:“Max Guests”,
      “value”:2
      },
      {
      “name”:“Min Stay”,
      “value”:30
      },
      {
      “name”:“Pets Allowed”,
      “value”:false
      }
    ],
    “duplicate_listings”:[
      {
      “id”:54321,
      “property_id”:09876,
      “source”:“VacationRentals”,
      “inquiryallowed”:false,
      “instantbook”:false,
      “price”:{
        “currency”:“USD”,
        “symbol”:“$”,
        “amount”:110
      }
      }
    ]
    }
  ]
  }
}
```

In the above sample code, the bounds may be used to update an area presented in the interactive map. The URL may be used to access the particular record when selected. The request for the URL may be passed to the geographic search engine and aggregator web server system 410 allowing the geographic search engine and aggregator web server system 410 to be aware of the record selected by the user. The geographic search engine and aggregator web server system 410 may then forward or redirect the browser to the URL associated with the property served by a third party geographic listing provider. Alternatively, the URL may be accessed directly by the user's browser.

Record request engine 511 may be configured to request additional records from geographic search engine and aggregator web server system 410. Record request engine 511 may include an exclusionary request that specifically excludes records that were provided as part of the first set. This exclusionary request may include the unique identifiers associated with each geographic listing of the first set of records currently stored by retrieved records database 515. In response to this request generated by record request engine 511, a second set of records may be provided by geographic search engine and aggregator web server system 410 to browser 510.

These geographic listing records of the second set may be stored similarly to the first set as part of retrieved records database 515. The content of geographic location listing records associated with the first set in the second set may be indistinguishable within retrieved records database 515, possibly with the exception of indication as to which records are to be associated with greater or lesser-emphasis geographic markers.

Emphasized record interface 514 can present the on-page record region, such as on-page record region 130 of FIG. 1, which corresponds to the greater-emphasis geographic markers presented on the interactive map. Emphasized record interface 514 may include HTML, XML, and/or JavaScript® code (or some other programming language code) that causes browser 510 to present the interface with which a user interacts, such as including search region 110. If the user clicks on a greater- or lesser-emphasis geographic marker within interactive map applet 512, interactive map applet 512 may pass the unique identifier associated with the marker to webpage execution engine 513. Webpage execution engine 513 may access the associated geographic listing record from retrieved records database 515. If the selected geographic markers associated with a greater-emphasis geographic marker, webpage execution engine 513 may cause emphasized record interface 514 to highlight and/or scroll to the corresponding on-page record within the on-page record region. If the selected geographic marker is associated with a lesser-emphasis geographic marker, webpage execution engine 513 may cause an overlay to be presented on interactive map applet 512 such that a thumbnail pop-up is presented on the interactive map in relation to the lesser-emphasis geographic marker. Information to present as part of the thumbnail pop-up may be retrieved from retrieved records database 515.

Geographic listing record 520 represents an exemplary record that may be stored as part of retrieved records database 515. Geographic listing record 520 may be substantially similar to geographic listing record 417 of FIG. 4. In some embodiments, geographic listing record 520 may contain less information than geographic listing record 417; that is, geographic search engine and aggregator web server system 410 may not send all data fields associated with a geographic listing record to browser 510. As an example, geographic listing record 520 may include some number of images 521, and various data fields 522, including a unique identifier, title, description, source (geographic listing provider), number of beds, number of baths, customer rating, and/or a nightly price. Geographic listing record 520 may store some of all of the record fields provided to retrieved records database as indicated in the code snippet provided above.

When a user provides input to emphasized record interface 514 and browser 510 that requests loading of an additional page of results, record request engine 511 may coordinate different geographic listing records being presented emphasized with previously presented emphasized geographic listing records being demoted to being lesser-emphasis geographic listing records. In some embodiments, record request engine 511 will resubmit a search request of the user with an indication that a second page (or some other grouping) of results be returned. In response, geographic search engine and aggregator web server system 410 may return a set of geographic listing records that have a lower rank than the initial set of geographic listing records provided for presentation with greater-emphasis geographic markers. After receipt, record request engine 511 may request additional records along with an exclusionary request to exclude the received set of geographic listing records. This second set of records are then presented with lesser-emphasis geographic markers.

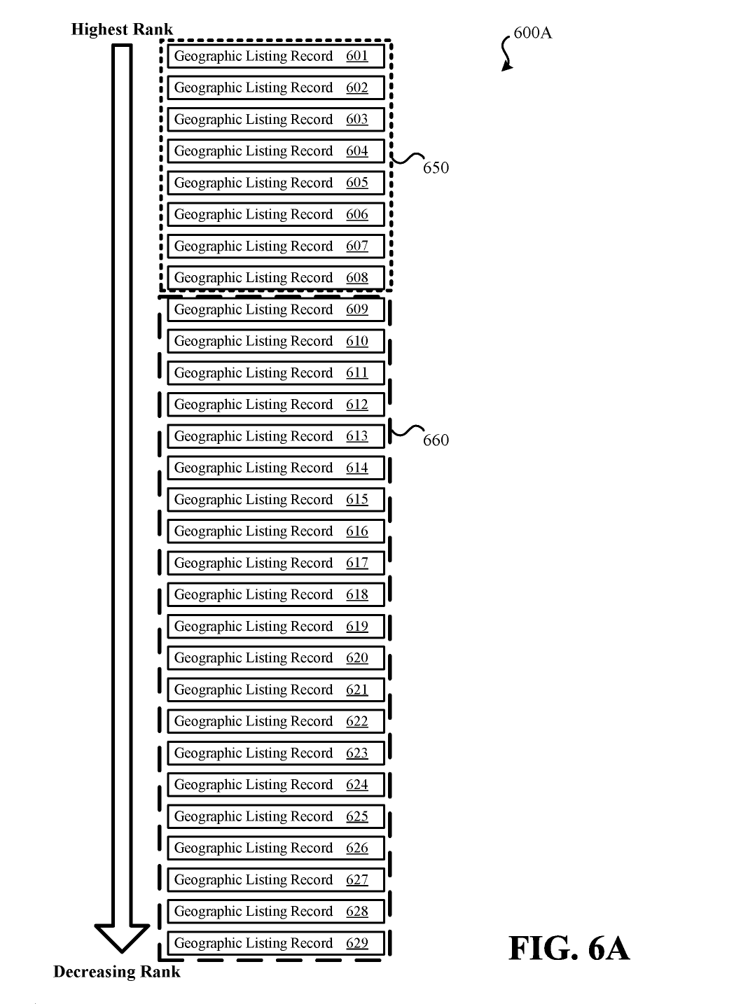

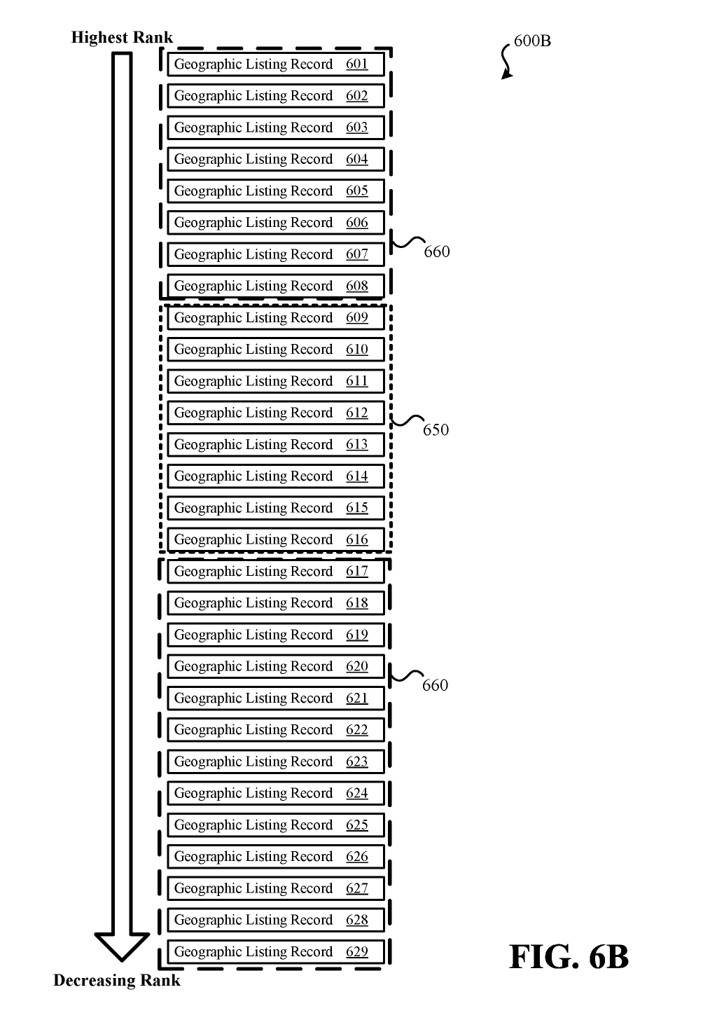

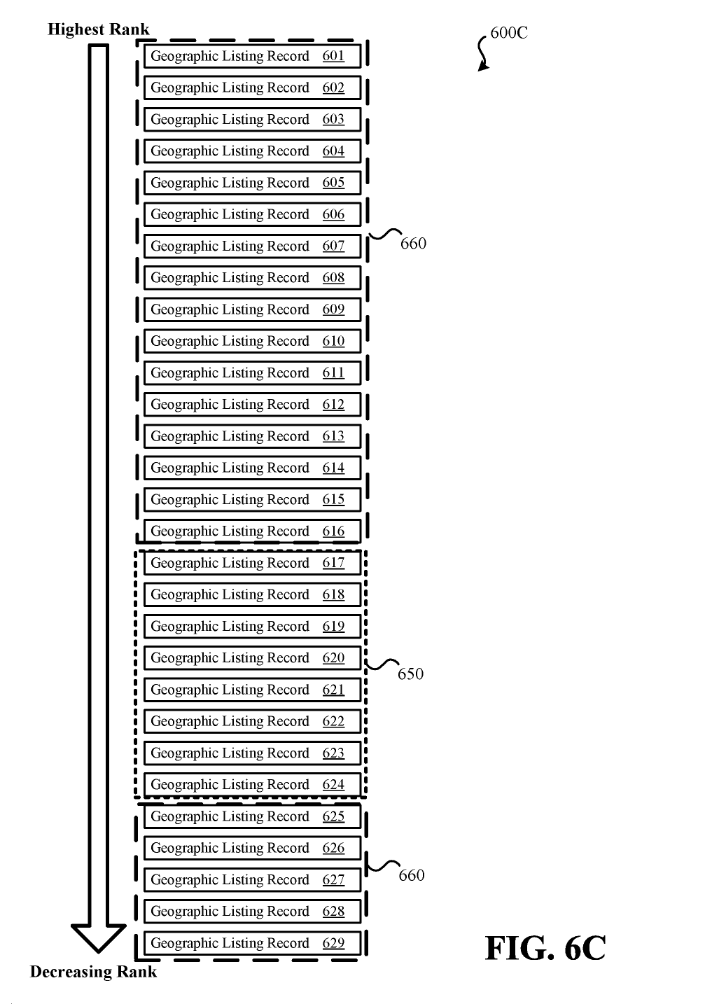

FIGS. 6A-6C represent embodiments of abstractions illustrating how geographic listing records are selected to be associated with either greater- or lesser-emphasis geographic markers. In response to a search submitted by a user, geographic search engine 413 in concert with ranking engine 414 of geographic search engine and aggregator web server system 410 may determine a listing of geographic listing records that match or most nearly match the search criteria. In FIG. 6A, geographic listing record 601 through geographic listing record 629 are listed in descending order from highest rank. Geographic listing record 629 does not represent the lowest ranked result overall, but rather the lowest ranked result of the 29 geographic listing records that most nearly match the search request as identified from listing database 412.

Webpage rendering engine 415 may select the first eight geographic listing records (geographic listing record 601 through geographic listing record 608) to be initially presented in the user's web browser in conjunction with greater-emphasis geographic markers. These geographic listing records to be presented in conjunction with greater-emphasis geographic markers are indicated by group 650. In response to the user's web browser requesting additional results from webpage rendering engine 415, webpage rendering engine 415 may provide geographic listing records 609 through 629. This request provided by the user's browser may include an exclusionary request that indicates identifiers associated with geographic listing records 601 through 608. Group 660 may be presented using lesser-emphasis geographic markers by the interactive map applet being executed by the user's browser.

If a user requests a second page of results, which geographic listing records are presented is associated with greater or lesser-emphasis geographic markers may be adjusted. In response to such a request for a second page of results, webpage rendering engine 415 may cause the next eight records to be presented as group 650, which are presented in conjunction with greater-emphasis geographic markers. Then, in response to a request from the browser for additional results, webpage rendering engine may indicate that geographic listing records indicated by group 660 in FIG. 6B are to be presented in conjunction with lesser-emphasis geographic markers. As can be seen in FIG. 6B, group 660 includes geographic listing records 601 through 608 and 617 through 629. Therefore, geographic listing records that were previously presented in conjunction with greater-emphasis geographic markers are now being presented in relation with lesser-emphasis geographic markers. Similarly, geographic listing records that were previously presented in conjunction with lesser-emphasis geographic markers are now being presented in conjunction with greater-emphasis geographic markers.

If a user requests a third page of results, which geographic listing records are presented is associated with greater or lesser-emphasis geographic markers may again be adjusted. In response to such a request for a third page of results, webpage rendering engine 415 may cause the next eight records to be presented as group 650, which are presented in conjunction with greater-emphasis geographic markers. Then, in response to a request from the browser for additional results, webpage rendering engine may indicate that geographic listing records indicated by group 660 in FIG. 6C are to be presented in conjunction with lesser-emphasis geographic markers. As can be seen in FIG. 6C, group 660 includes geographic listing records 601 through 616 and 625 through 629. Therefore, geographic listing records that were previously presented in conjunction with greater-emphasis geographic markers are now being presented in relation with lesser-emphasis geographic markers. Similarly, geographic listing records that were previously presented in conjunction with lesser-emphasis geographic markers are now being presented in conjunction with greater-emphasis geographic markers.

As a user continues to select additional pages of results, the adjusting of which geographic listing records are presented in conjunction with greater or lesser geographic markers may continue to shift. If the user eventually requests all pages of results, every geographic listing record that was presented with a lesser-emphasis geographic marker may, at least in association with one page, be presented in conjunction with a greater-emphasis geographic marker.

Therefore, whether a geographic listing record is presented in conjunction with a greater or lesser geographic marker is based on the output of ranking engine 414 and not on, for example, an entity associated with a particular geographic listing record paying a fee or otherwise causing the particular geographic listing record to be presented as emphasized compared to other results.

While the above description refers to a user requesting discrete pages of results, it should be understood that such an arrangement may be applied within the browser in an “infinite scrolling” arrangement. In such an arrangement, if a user scrolls through the on-page record region beyond a threshold location, the scrolling may be treated as the user effectively requesting the next page of results.

In some embodiments, geographic listing record 601 through 629 are only loaded into the user's browser a single time and user requests related to later pages of results being presented with greater or lesser-emphasis geographic indicators may result in webpage rendering engine 415 altering such geographic listing records as stored by browser 510 in retrieved records database 515. In other embodiments, whenever a user requests a next page of results, the entire search may be re-performed using the same search criteria by geographic search engine 413 and ranked by ranking engine 414. The proper grouping of geographic listing records may be assigned greater and lesser-emphasis geographic markers based on the exclusionary command issued by record request engine 511 to webpage rendering engine 415.

While the exemplary embodiments of FIGS. 6A-6C involves the ranking of 29 records with eight records being emphasized at a given time, it should be understood that such numbers of records being emphasized is merely exemplary. Greater or fewer numbers of records may be returned, presented in conjunction with greater-emphasized geographic markers and/or presented in conjunction with lesser-emphasized geographic markers.

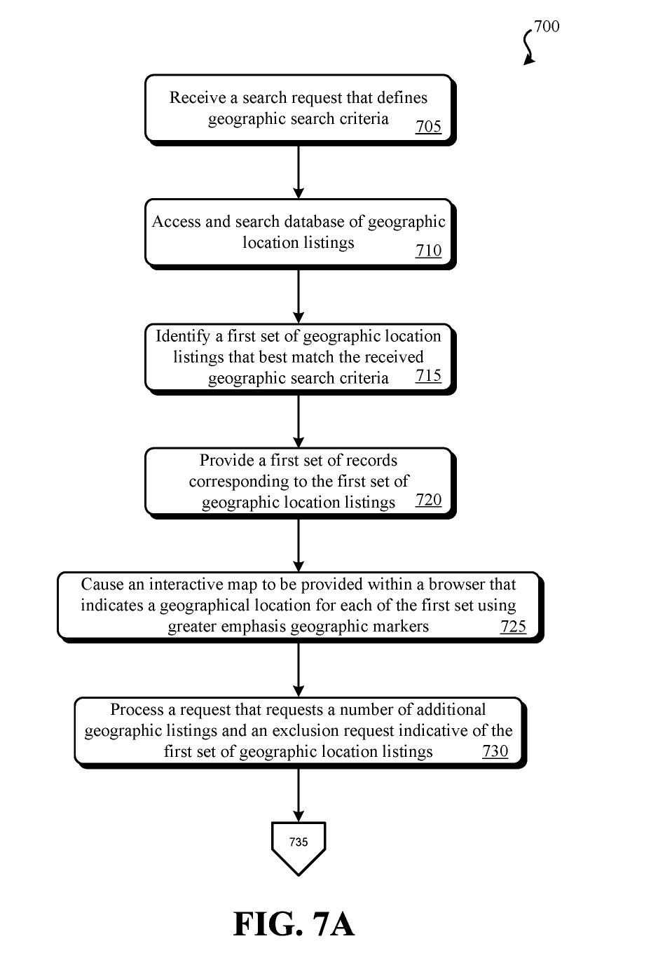

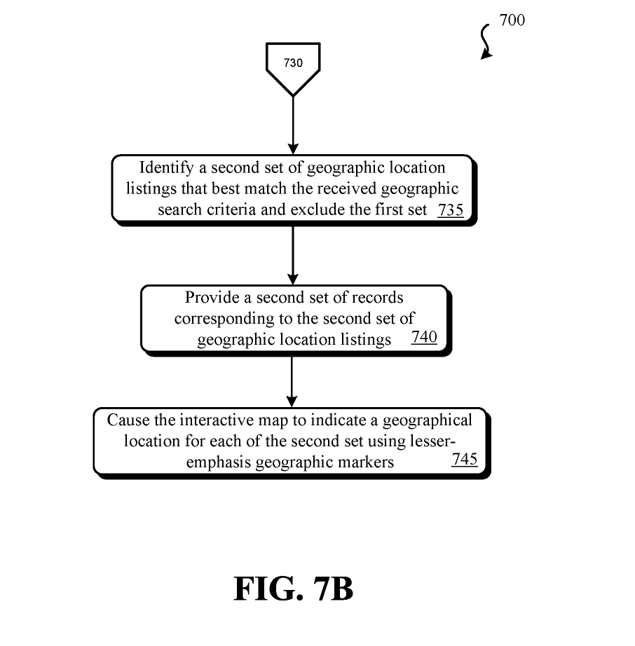

FIGS. 7A and 7B illustrate an embodiment of a method 700 for providing a web-based geographic location search engine interface in a user's web browser. Method 700 may be performed using the systems of FIGS. 4 and 5 to provide an interface similar to the exemplary embodiments of FIGS. 1-3. For instance, each step of method 700 may be performed using system 400. More specifically, each step of method 700, unless otherwise noted, may be performed using geographic search engine and aggregator web server system 410 of FIG. 4.

At block 705, a search request that defines a geographic search area and, possibly, contains additional search criteria, may be received. Block 705 may include a user submitting an address, location (e.g., zip code, city name, region name, coordinates), and/or tracing, circling or otherwise manipulating an interactive map to display a particular region in which the end-user is interested in viewing listings. The search criteria may include particular characteristics that the end-user is desiring in a particular listing property, such as a number of bedrooms, a number of bathrooms, a type of property (e.g., condo, stand-alone home, studio apartment), price range, and/or availability for particular dates. Such additional search criteria may match one or more of the fields stored by geographic search engine and aggregator web server system 410 within geographic listing records such as geographic listing record 417.

The definition of a map boundary and/or a geographic region may be determined based on the geographic search area specified in the search request of block 705. At block 710, the web server system may access a listing database to identify multiple geographic listing records that fall within the definition of the map boundary and/or match (or most nearly match) the search criteria received from the end-user at block 705.

At block 715, a first set of geographic location listings from the listing database may be retrieved. This first set may represent the highest ranked matches. Therefore, this first set of results most nearly satisfies the user's search criteria and/or is highly ranked for additional reasons (e.g., high customer rating for the listing). This first set of records may be transmitted to the user's browser at block 720. Along with the first set of records, code that causes an interface within the user's browser may also be transmitted to the user's browser. This code may include code that calls an interactive map from a third party map provider system and code that causes an on-page record region to be rendered. The first set of records, as transmitted to the user's browser, may contain information that matches or is similar to geographic listing record 520 of FIG. 5. The code provided to the user's browser may include HTML, XML, and/or JavaScript®, as three examples of possible types of coding included in the web-based interface.

At block 725, the code provided to the browser may include code that causes an interactive map applet to execute and to call a provider system for a map for a defined region. The code provider to the browser may: define a map region using coordinates (e.g., latitude and longitude coordinates), define locations (e.g., latitude and longitude coordinates) at which greater-emphasis geographic markers are to be placed on the map, and a graphic to be used as the greater-emphasis geographic marker. The map provider system may then supply the rendered map directly to the map interface applet being executed by the browser.

As detailed in relation to FIGS. 5-6C, after receiving and storing the first set of geographic listings, the browser can send a request for additional geographic listings that match or nearly match the user's search request. This request may include an exclusion request, which can be embedded as part of a request, such as a JavaScript Object Notation (JSON) request:

https://www.tripping.com/search/remote?currency=usd&bedrooms=0&bathrooms=0&type=
Any&show-without-price=checked&price-
range=10%3B100000&numguests=1&search-
input=San+Francisco&bounds%5Bnorth%5D=37.86969726941999&bounds%5Bsouth%
5D=37.59926525358023&bounds%5Beast%5D=−
122.25405010302734&bounds%5Bwest%5D=−
122.64475139697265&lat=37.73460473151931&long=−122.44940075&exclude-
ids=26114098%2C23588773%2C23347807%2C23348394%2C23348428%2C23348459
%2C23348851%2C23348867%2C23349055%2C23349568%2C23351292%2C23351941
%2C23351957%2C23355140%2C23356093%2C23357710%2C23360066%2C23360078
%2C23360821%2C23361942%2C15067345%2C18949014%2C15985948%2C18949484
%2C15994976%2C18954429%2C15995536%2C18957565%2C16001083%2C18964364
%2C16033431%2C18966423%2C16185428%2C18966569%2C16185429%2C18968066

Within the above request, various property identifiers are specifically excluded such that the additional results are provided that match the search conditions (e.g., geographic bounds, number of bedrooms, and price range) within the request but exclude the specifically listed property identifiers.

At block 730, this request which includes the exclusion command, may be received and processed by the geographic search engine and aggregator web server system. In some embodiments, at block 710, this search of the listings database yielded both a first set and a second set of geographic listing records (e.g., in the form of one superset from which only the first set was provided to the browser at block 720). the results of this initial search may have been stored by the geographic search engine and aggregator web server system. In other embodiments, the search is not stored and in response to the request of block 730, the full search may be performed again by the geographic search engine according to the same search criteria such that the same results are obtained again.

At block 735, whether the search is re-executed by the geographic search engine or the previous results are accessed from a store location, a second set of geographic location listings that best match the received geographic search criteria and also exclude the first set of results that have already been provided to the browser are identified. At block 740, this second set of geographic listing records is provided and transmitted to the browser. Second geographic listing records may be the same as the first set, however indications may be present at the second set of geographical listing records to be presented in conjunction with lesser-emphasis geographic indicators. The second set of records being provided at block 740 may include the webpage rendering engine of the geographic search engine and aggregator web server system providing code that is used by the interactive map applet. This code may include location coordinates for each of the second set of geographic listing records and a graphic to be used as the lesser-emphasis geographic marker. The browser, upon receiving the code may transfer the coordinates and graphic to the map provider system through the map provider system's API. The interactive map presented via the browser may then be updated at block 745 to include the lesser-emphasis geographic indicators corresponding to the second set of geographic listing records. In other embodiments, the map provider's API may be provided with indications of both the lesser and greater-emphasis geographic markers at a single time such that the map is updated to a single time to show both the lesser- and greater-emphasis geographic markers. That is, presentation of the interactive map may occur only after coordinates for both the first and second set of geographic listing records been provided to the map provider system's API and the rendered map that includes the greater- and lesser-emphasis geographic markers has been returned to the browser.

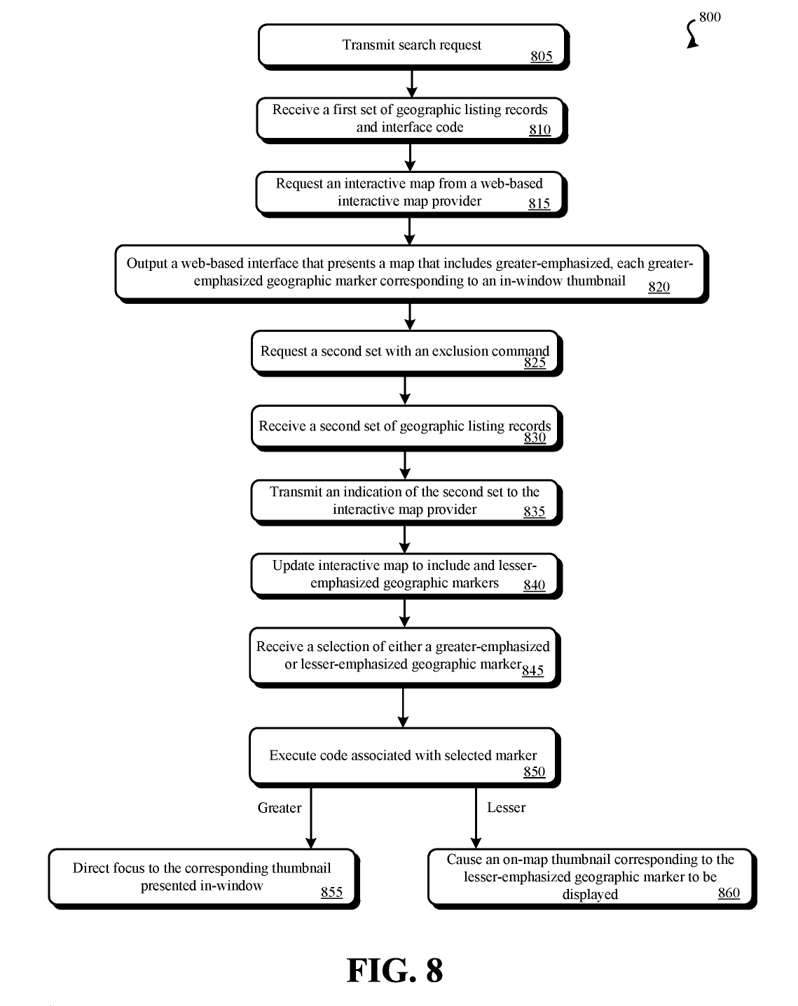

FIG. 8 illustrates an embodiment of a method 800 for executing the web-based geographic location search engine interface in a user's web browser. Method 800 may be performed by a browser of an end-user computing system while steps of method 700 are being performed by the geographic search engine and aggregator web server system. Method 800 may be performed using the systems of FIGS. 4 and 5 to provide an interface similar to the exemplary embodiments of FIGS. 1-3. For instance, each step of method 800 may be performed using system 400. More specifically, each step of method 800, unless otherwise noted, may be performed using an end user computing system, such as end-user computing system 440-1.

At block 805, a search request that includes an indication of a geographical area to be searched and additional search criteria may be transmitted to the geographic search engine and aggregator web server system. In response, at block 810, a first set of geographic listing records may be received. Code may also be received to present the interface within the browser. For example, referring to FIG. 5, browser 510 may receive code for: interactive map applet 512, webpage execution engine 513, record request engine 511, emphasized record interface 514 and retrieved records database 515.

At block 815, the interactive map may be requested. The interactive map may be requested through a map provider system's API. Information that may be provided to the map provider system may include: coordinates to define a geographic region for the map, coordinates that correspond to locations to receive greater-emphasis geographical markers, a graphic to use as a greater-emphasis geographical marker, and code that is to be executed upon each greater emphasis-marker being selected by a user.
At block 820, the web-based interface may be output by the web browser for presentation to the user. The web-based interface may be similar to those presented in relation to FIGS. 1-3. The web-based interface may include the interactive map that indicates greater-emphasized geographic markers each of these geographic markers being associated with a geographic listing records stored by the browser. Each of the greater-emphasis geographic markers may be associated with a presented on-page record that is presented within the on-page record region of the webpage.
At block 825, the browser may transmit a request for a second set of geographic listing results. This request may include an exclusion command indicative of the geographic listing records of the first set. At block 830, the second set of geographic listing records may be received by the browser and may be stored locally in the retrieved records database.
At block 835, an indication of the second set of geographic listing results may be provided to the web-based interactive map provider system. Information that may be provided to the map provider system may include: coordinates that correspond to locations to receive lesser-emphasis geographical markers, a graphic to use a lesser-emphasis geographical marker, and code that is to be executed upon each greater lesser-marker being selected by a user. In response, at block 840, the interactive map may be updated to include lesser-emphasis geographic markers that correspond to the second set of geographic listing results. It should be noted that block 825 through 840 may be repeated for additional sets of geographic results.

At block 845, a selection of either an emphasized or non-emphasized geographic marker on the interactive map may be received. The interactive map applet hosting the interactive map may determine a unique identifier associated with the geographic marker selected and may pass this unique indicator to the webpage execution engine being executed by the browser. At block 850, code associated with the selected marker is executed—each marker may be associated with its own code.

If at block 850 the code executed is associated with a greater-emphasis geographic marker, the code being executed by the browser may cause an emphasized record interface to scroll, if necessary, within on-page record region to the corresponding on-page record and the on-page record may be highlighted at block 855. If the user selects this on-page record, the unique identifier may be transmitted to the geographic search engine and aggregator web server system, which may in turn forward the browser to the appropriate page hosted by a geographic listing provider server system of geographic listing provider server systems 430.

If at block 850 the code executed is associated with a lesser-emphasis geographic marker, an on-page thumbnail corresponding to the lesser-emphasis geographic marker may be displayed as overlaid on the interactive map at block 860. Data that is used to be presented as part of the on-map thumbnail may be retrieved from the locally stored geographic listing record within the retrieved records database. If the user selects this on-map thumbnail, the unique identifier that is stored as part of the geographic listing record may be transmitted to the geographic search engine and aggregator web server system. The system may in turn forward the browser to the appropriate page hosted by a geographic listing provider server system of geographic listing provider server systems 430.

Rather than specific code being associated with each marker at block 850, in another possible embodiment, at block 850, the webpage execution engine may determine whether the selected marker is a greater- or lesser-emphasized geographic marker. This may be accomplished by performing a lookup using the unique identifier to access the stored geographic listing record associated with the identifier. The geographic listing record may include an indication of whether the geographic listing record is currently being presented in conjunction with a greater or lesser-emphasis geographic marker. In other embodiments, the interactive map applet may pass back an indication of which type of markers are being used in conjunction with the identifier. In still other embodiments, a table may be maintained that indicates which geographic listing records are associated with greater- or lesser-emphasis geographic markers.

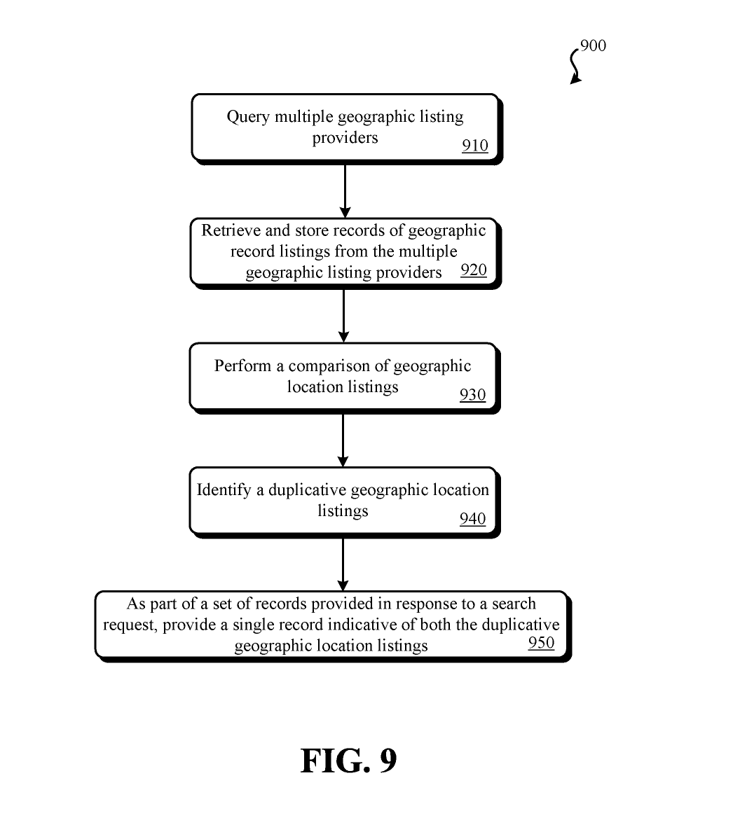

FIG. 9 illustrates an embodiment of a method 900 for identifying duplicate geographic location listings and incorporating such duplicate geographic location listings in results. Method 900 may be performed by a geographic search engine and aggregator web server system, such as by duplicate matching engine 416 (unless otherwise noted) of geographic search engine and aggregator web server system 410 of FIG. 4. When retrieving listings from multiple geographic listing provider server systems, a same geographic listing may be available at more than one (e.g., two, three, more than three) geographic listing provider server system. These listings may not be identical (e.g., price may vary), but may have several fields in common. For instance, a set of coordinates associated with each listing may match, either exactly or within a threshold distance. Also fields for title and description may match or nearly match. One or more photos may also match. Such similarities can be used to identify matching geographic listings. Such matching listings may be presented similarly to the listing associated with duplicate listing interface 132. Duplicate listing interface 132 may allow a user to select which geographic listing provider he desires to interact. Based on the user's selection, the user's browser may be forwarded to the geographic listing hosted by the selected geographic listing provider.

At block 910, listing aggregation engine 411 may query multiple geographic listing provider server systems for geographic listings, such as detailed in relation to FIG. 4. These records may be retrieved and stored at block 920. At block 930, a comparison of geographic listing records may be performed to identify identical or substantially identical geographic listing records obtained from different geographic listing provider server systems. The comparison may first involve identifying geographic listing records that are both associated with substantially the same location. In some embodiments, this location may be required to exactly match. In other embodiments, as long as a substantial match, such as within a predefined distance, is present, the locations may be determined to match. In some embodiments, the location match may be determined based on the two listings being associated with a same address. The comparison performed a block 930 may involve one or more additional fields of the geographic listing records being compared, such as titles associated with the geographic listing records, images associated with the geographic listing records, and descriptions provided for the geographic listing records.

At block 940, two geographic listing records obtained from different geographic listing provider server systems may be determined to be associated with a same listing property if a perfect match is determined by the comparison of block 930. In other embodiments, a perfect match may not be necessary, but rather a score may be computed based on the comparison between the geographic listing records. When the score exceeds a particular threshold value, the geographic listing records may be determined to match. Such matching records may be combined into a single record or may be linked together such that the matching records are linked with each other.

At block 950, when a duplicate of geographic listing record is provided in response to a search request of the user, only a single compiled geographic listing record that is indicative of both the duplicate geographic listing records may be provided. This compiled geographic listing record may include multiple unique identifiers such that each unique identifier is linked with a different geographic listing provider server system. Only a single location, title, description, number of beds, and number of baths may be provided for such a compiled geographic listing record. However, multiple sources may be included that indicate the multiple geographic listing providers from which the duplicative geographic listing records were obtained. Separate prices may also be stored as part of the compiled geographic listing record. When either an on-page record or a pop-up thumbnail corresponding to the compiled geographic listing record is presented, the user may be permitted to select from among the available prices and the available geographic listing provider server systems, thus allowing the user to be forwarded to the geographic listing record as hosted by the geographic listing provider server system with which the user prefers to interact.

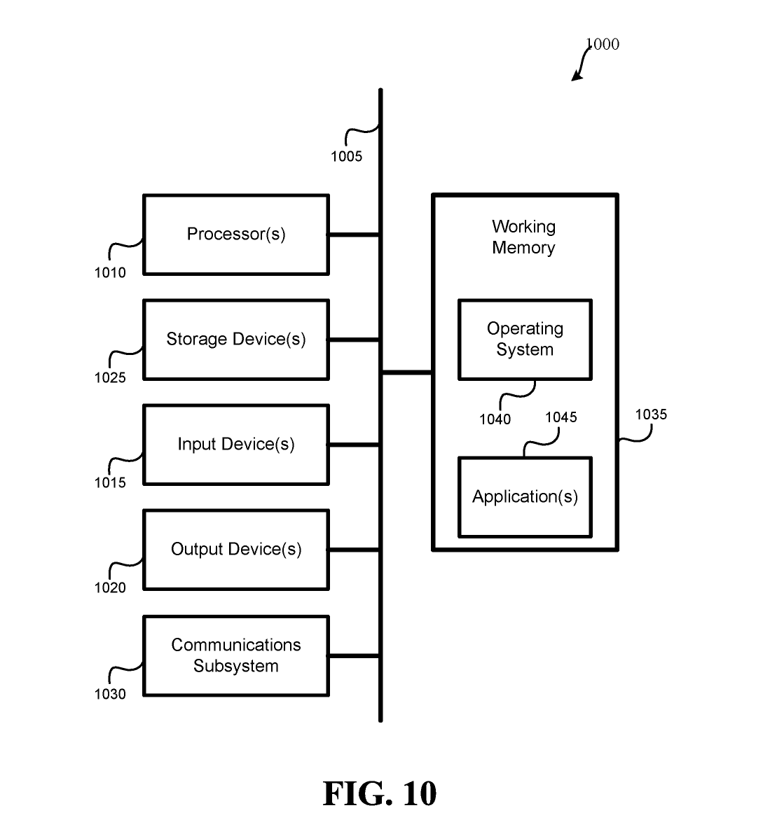

FIG. 10 illustrates an embodiment of a computer system. Computer system 1000 may be incorporated as part of any the previously described end-user computing systems, the geographic search engine and aggregator web server system, map provider system, and/or as a geographic listing provider server system. FIG. 10 provides a schematic illustration of one embodiment of a computer system 1000 that can perform various steps of the methods provided by various embodiments. It should be noted that FIG. 10 is meant only to provide a generalized illustration of various components, any or all of which may be utilized as appropriate. FIG. 10, therefore, broadly illustrates how individual system elements may be implemented in a relatively separated or relatively more integrated manner.

The computer system 1000 is shown comprising hardware elements that can be electrically coupled via a bus 1005 (or may otherwise be in communication, as appropriate). The hardware elements may include one or more processors 1010, including without limitation one or more general-purpose processors and/or one or more special-purpose processors (such as digital signal processing chips, graphics acceleration processors, video decoders, and/or the like); one or more input devices 1015, which can include without limitation a mouse, a keyboard, remote control, and/or the like; and one or more output devices 1020, which can include without limitation a display device, a printer, and/or the like.

The computer system 1000 may further include (and/or be in communication with) one or more non-transitory storage devices 1025, which can comprise, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable and/or the like. Such storage devices may be configured to implement any appropriate data stores, including without limitation, various file systems, database structures, and/or the like.

The computer system 1000 might also include a communications subsystem 1030, which can include without limitation a modem, a network card (wireless or wired), an infrared communication device, a wireless communication device, and/or a chipset (such as a Bluetooth™ device, an 802.11 device, a WiFi device, a WiMax device, cellular communication device, etc.), and/or the like. The communications subsystem 1030 may permit data to be exchanged with a network (such as the network described below, to name one example), other computer systems, and/or any other devices described herein. In many embodiments, the computer system 1000 will further comprise a working memory 1035, which can include a RAM or ROM device, as described above.

The computer system 1000 also can comprise software elements, shown as being currently located within the working memory 1035, including an operating system 1040, device drivers, executable libraries, and/or other code, such as one or more application programs 1045, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the non-transitory storage device(s) 1025 described above. In some cases, the storage medium might be incorporated within a computer system, such as computer system 1000. In other embodiments, the storage medium might be separate from a computer system (e.g., a removable medium, such as a compact disc), and/or provided in an installation package, such that the storage medium can be used to program, configure, and/or adapt a general purpose computer with the instructions/code stored thereon. These instructions might take the form of executable code, which is executable by the computer system 1000 and/or might take the form of source and/or installable code, which, upon compilation and/or installation on the computer system 1000 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 1000) to perform methods in accordance with various embodiments of the invention. According to a set of embodiments, some or all of the procedures of such methods are performed by the computer system 1000 in response to processor 1010 executing one or more sequences of one or more instructions (which might be incorporated into the operating system 1040 and/or other code, such as an application program 1045) contained in the working memory 1035. Such instructions may be read into the working memory 1035 from another computer-readable medium, such as one or more of the non-transitory storage device(s) 1025. Merely by way of example, execution of the sequences of instructions contained in the working memory 1035 might cause the processor(s) 1010 to perform one or more procedures of the methods described herein.

The terms “machine-readable medium,” “computer-readable storage medium” and “computer-readable medium,” as used herein, refer to any medium that participates in providing data that causes a machine to operate in a specific fashion. These mediums may be non-transitory. In an embodiment implemented using the computer system 1000, various computer-readable media might be involved in providing instructions/code to processor(s) 1010 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the non-transitory storage device(s) 1025. Volatile media include, without limitation, dynamic memory, such as the working memory 1035.

Common forms of physical and/or tangible computer-readable media include, for example, a floppy disk, a flexible disk, hard disk, magnetic tape, or any other magnetic medium, a CD-ROM, any other optical medium, any other physical medium with patterns of marks, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 1010 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 1000.

The communications subsystem 1030 (and/or components thereof) generally will receive signals, and the bus 1005 then might carry the signals (and/or the data, instructions, etc. carried by the signals) to the working memory 1035, from which the processor(s) 1010 retrieves and executes the instructions. The instructions received by the working memory 1035 may optionally be stored on a non-transitory storage device 1025 either before or after execution by the processor(s) 1010.

It should further be understood that the components of computer system 1000 can be distributed across a network. For example, some processing may be performed in one location using a first processor while other processing may be performed by another processor remote from the first processor. Other components of computer system 1000 may be similarly distributed. As such, computer system 1000 may be interpreted as a distributed computing system that performs processing in multiple locations. In some instances, computer system 1000 may be interpreted as a single computing device, such as a distinct laptop, desktop computer, or the like, depending on the context.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A method for geographic location linked searching and record access, the method comprising:
receiving, by a geographic search system, a first request from a browser of a user computer system that comprises geographic search criteria;
accessing, by the geographic search system, a database to retrieve geographic location listings that are within a geographic region defined by the geographic search criteria;
identifying, by the geographic search system, a first set of geographic location listings that match the geographic search criteria;
transmitting, by the geographic search system, to the browser of the user computer system, a first set of records that indicate the first set of geographic location listings;
causing, by the geographic search system, an interactive map to be provided to the browser of the user computer system, the interactive map comprising a plurality of greater-emphasis geographic markers, wherein each greater-emphasis geographic marker of the plurality of greater-emphasis geographic markers corresponds to a geographic location listing of the first set of geographic location listings;
after receiving the first set of records and in response to the instance of user input, transmitting, by the browser of the user computer system, a second request that comprises: a request for additional geographic location listings and an exclusion request, wherein the exclusion request indicates the first set of geographic location listings;
identifying, by the geographic search system, a second set of geographic location listings that match the geographic search criteria and excludes the first set of geographic location listings;
transmitting, by the geographic search system, to the browser of the user computer system, a second set of records that indicate the second set of geographic location listings; and
causing, by the geographic search system, the interactive map to present a plurality of lesser-emphasis geographic markers concurrently with the plurality of greater-emphasis geographic markers, wherein each lesser-emphasis geographic marker of the plurality of lesser-emphasis geographic markers corresponds to a geographic location of the second set of geographic location listings.

2. The method of claim 1, further comprising:
transmitting, by the geographic search system, instructions to the browser of the user computer system that causes a window of the browser to simultaneously present: a plurality of graphical record listings, wherein each graphical record listing of the plurality of graphical record listings correspond to a different record of the first set of records; and the interactive map.

3. The method of claim 2, further comprising:
transmitting, by the geographic search system, instructions to the browser of the user computer system that cause the browser to simultaneously present with the plurality of graphical record listings and the interactive map, a single popup graphical record listing overlaid onto the interactive map in response to user selection of a lesser-emphasis geographic marker.

4. The method of claim 1, wherein causing the interactive map to be provided to the browser of the user computer system, comprises:
transmitting, by the browser, to a third-party map provider application programming interface: coordinates indicative of the geographic region, a first image corresponding to the greater-emphasis geographic marker, a second image corresponding to the lesser-emphasis geographic marker, identifiers corresponding to the first set of records and the second set of records, and coordinates corresponding to each record of the first set of records and the second set of records; and
receiving, directly from the third-party map provider, by the browser of the user computer system, the interactive map that comprises the plurality of lesser-emphasis geographic markers and the plurality of greater-emphasis geographic markers.

5. The method of claim 1, further comprising:
accessing, by the geographic search system, a plurality of third-party geographic listing APIs to retrieve records corresponding to a superset of geographic location listings;
updating, by the geographic search system, the database that includes a superset of records corresponding to the superset of geographic location listings; and
comparing records of the superset of records with each other to identify duplicative records, wherein duplicative records correspond to a same geographic location listing.

6. The method of claim 5, wherein comparing the records of the superset of records with each other to identify duplicative records comprises:
comparing a first record received from a first third-party geographic listing API with a second record received from a second third-party geographic listing API based on geographic coordinates, record title, and images; and
identifying that the first record and the second record are duplicative based on the comparison.

7. The method of claim 6, wherein transmitting the first set of records that indicate the first set of geographic location listings to the browser comprises a single record indicative of: the first record received from the first third-party geographic listing API and the second record received from the second third-party geographic listing API.

8. The method of claim 1, further comprising:
receiving, by the browser, user selection of a record selected from the first set of records or the second set of records;
transmitting, by the browser, an indication of the record to the geographic search system; and
causing, by the browser, either the greater-emphasis geographic marker or the lower-emphasis geographic marker associated with the record to be presented on the interactive map to be changed from a first graphical format to a second graphical format.

9. The method of claim 1, further comprising:
storing, by the browser of the user computer system, the first set of records and the second set of records as a single set of records in a common format.

10. The method of claim 1, further comprising:
in response to selection of a greater-emphasis geographic marker, identifying, by the browser of the user computer system, a graphical record listing of a plurality of graphical record listings corresponding to the greater-emphasis geographic marker; and
executing, by the browser of the user computer system, an automated scroll event such that the graphical record listing is presented simultaneously with the selected greater-emphasis geographic marker.

11. A system for providing a web-based map interface, the system comprising:
one or more processors; and
a memory communicatively coupled with and readable by the one or more processors and having stored therein processor-readable instructions which, when executed by the one or more processors, cause the one or more processors to:
receive geographic search criteria that defines a geographic region;
access a geographic search system to retrieve a plurality of listings that correspond to the defined geographic region;
cause, within a browser window, an interactive map interface to be presented;
cause, on the interactive map interface, a plurality of greater-emphasis geographic markers and a plurality of lesser-emphasis geographic markers to be placed, the plurality of greater-emphasis geographic markers corresponding to a first subset of the plurality of listings and the plurality of lesser-emphasis geographic markers corresponding to a second subset of the plurality of listings;
cause, within the browser window presenting the interactive map interface, a plurality of listing thumbnails to be presented, wherein:
each greater-emphasis geographic marker of the plurality of greater-emphasis geographic markers corresponds to a listing thumbnail of the plurality of listing thumbnails.

12. The system for providing the web-based map interface of claim 11, wherein the processor-readable instructions, when executed, further cause the one or more processors to:
receive a selection of a lesser-emphasis geographic marker; and
cause, on the interactive map interface, in response to the selection of the lesser-emphasis geographic marker, a pop-up thumbnail to be presented over the interactive map interface based on a geographic location of the lesser-emphasis geographic marker.

13. The system for providing the web-based map interface of claim 11, wherein the processor-readable instructions that, when executed, cause the one or more processors to cause the interactive map to be provided to the browser of the user computer system comprise processor-readable instructions which, when executed, cause the one or more processors to:
transmit, by the browser, to a third-party map provider application programming interface: coordinates indicative of the geographic region, a first image corresponding to the greater-emphasis geographic marker, a second image corresponding to the lesser-emphasis geographic marker, identifiers corresponding to the first set of records and the second set of records, and coordinates corresponding to each record of the first set of records and the second set of records; and
receive, from the third-party map provider, by the browser of the user computer system, the interactive map that comprises the plurality of lesser-emphasis geographic markers and the plurality of greater-emphasis geographic markers.

14. The system for providing the web-based map interface of claim 11, wherein the processor-readable instructions, when executed, further cause the one or more processors to:
receive a selection of a greater-emphasis geographic marker associated with a graphical record listing; and
execute an automated scroll event such that the graphical record listing is presented simultaneously with the selected greater-emphasis geographic marker.

15. The system for providing the web-based map interface of claim 11, wherein the processor-readable instructions, when executed, further cause the one or more processors to:
receive user selection of a record selected from the first set of records or the second set of records;
cause either the greater-emphasis geographic marker or the lower-emphasis geographic marker associated with the record to be presented on the interactive map to be changed from a first graphical format to a second graphical format.

16. A non-transitory processor-readable medium for providing a web-based map interface, comprising processor-readable instructions configured to cause one or more processors to:
receive geographic search criteria that defines a geographic region from an end user computerized device;
access a database to retrieve a plurality of listings that correspond to the defined geographic region;
cause, within a browser window, an interactive map interface to be presented on the end user computerized device;
cause, on the interactive map interface, a plurality of greater-emphasis geographic markers and a plurality of lesser-emphasis geographic markers to be placed, the plurality of greater-emphasis geographic markers corresponding to a first subset of the plurality of listings and the plurality of lesser-emphasis geographic markers corresponding to a second subset of the plurality of listings;
cause, within the browser window presenting the interactive map interface, a plurality of listing thumbnails to be presented, wherein:
each greater-emphasis geographic marker of the plurality of greater-emphasis geographic markers corresponds to a listing thumbnail of the plurality of listing thumbnails.

17. The non-transitory processor-readable medium of claim 16, wherein the processor-readable instructions are further configured to cause the one or more processors to:
access a plurality of third-party geographic listing APIs to retrieve records corresponding to a superset of geographic location listings;
update the database that includes a superset of records corresponding to the superset of geographic location listings; and
compare records of the superset of records with each other to identify duplicative records, wherein duplicative records correspond to a same geographic location listing.

18. The non-transitory processor-readable medium of claim 17, wherein the processor-readable instructions that, when executed, cause the one or more processors to compare the records of the superset of records with each other to identify duplicative records comprise processor-readable instructions which, when executed, cause the one or more processors to:
compare a first record received from a first third-party geographic listing API with a second record received from a second third-party geographic listing API based on geographic coordinates, record title, and images; and
identify that the first record and the second record are duplicative based on the comparison.

19. The non-transitory processor-readable medium of claim 18, wherein the processor-readable instructions that, when executed, cause the one or more processors to transmit the first set of records that indicate the first set of geographic location listings to the browser comprise processor-readable instructions which, when executed, cause the one or more processors to:
transmit a single record indicative of: the first record received from the first third-party geographic listing API and the second record received from the second third-party geographic listing API.

20. The non-transitory processor-readable medium of claim 16, wherein the processor-readable instructions are further configured to cause the one or more processors to:
transmit code to the end user computerized device that causes an automated scroll event to occur on the plurality of listing thumbnails in response to selection of a greater-emphasis geographic marker on the interactive map.
